(19) United States
(12) Patent Application Publication
(10) Pub. No.: US 2015/0081472 A1
(43) Pub. Date: Mar. 19, 2015

(54) Computational Size Selection For Off The Shelf Garments

(71) Applicant: LympheDIVAs, Pittsfield, MA (US)

(72) Inventors: Howard A. Levin, Pittsfield, MA (US); Joshua A. Levin, Pittsfield, MA (US)

(73) Assignee: LympheDIVAs, Pittsfield, MA (US)

(21) Appl. No.: 14/052,561

(22) Filed: Oct. 11, 2013

Related U.S. Application Data
(60) Provisional application No. 61/879,534, filed on Sep. 18, 2013.

(51) Int. Cl. G06Q 30/06

(52) U.S. Cl. CPC G06Q 30/0623
USPC 705/26.7

(57) ABSTRACT

Computational systems may be provided to assist with compression garment recommendations. A measurement of a person's body part may be received, and a compression expected to be applied may be computed. The expected compression may be based upon an arm measurement and upon a known relationship between a size of the garment, such as a stretched circumference, and the compression applied to an object that stretches the garment to that circumference. Graphs and formulas may be used to represent physical properties of a compression garment by assigning compression levels for ranges of relevant circumferences for a multitude of points along a limb. Information about needs of a patient, patient's condition, compression sensitivity, desired compression class, or desired use may be considered as part of a computational analysis to assist in fitting garments. The disclosed recommendation systems may assist clinicians, patients, consumers, or other users in selecting suitable off-the-shelf compression garments.

### RELATED APPLICATION(S)

This application claims the benefit of U.S. Provisional Application No. 61/879,534, filed on Sep. 18, 2013.

The entire teachings of the above application are incorporated herein by reference.

### BACKGROUND

Compression garments may be used to treat or prevent lymphedema or vascular insufficiency. Off-the-shelf compression garments may be selected based upon sizing or fitting charts and pressure levels that are provided by garment manufacturers. Typically, the average pressures are given in a range, such as 20-30 mmHg, which applies for a given range of circumferences or patient arm sizes. Alternatively, custom-fit compression garments may be recommended for some patients. Clinicians, therapists, or other experts may be required to fit compression garments to meet a patient's individual needs.

### SUMMARY

A consumer or clinician is often left with insufficient information when trying to select the appropriate compression garment using a sizing chart and starting pressure levels that are provided by manufacturers. Pressure ranges for garments can apply to a given range of circumferences. This circumference range is often large, which may make it more difficult to understand the compression provided by the garment, especially beyond an initial distal measurement. An individual consumer may fit into several sizes or have parts of his or her arm that fit into different sizes.

While standard fitting charts are available, there are limitations as to their effectiveness and confusion as to their use. Patients often receive a recommendation for a custom fit garment, even though a custom fit garment is often far more expensive than an off-the-shelf compression garment, even though it may not be medically necessary. The average retail cost of an off-the-shelf compression garment could be $50-120, whereas a custom garment could cost five to ten times that much. Given that these garments are usually only guaranteed to be effective for a life of six months, the extra cost of custom compression garments to the consumer or health care insurer can quickly reach thousands of dollars.

Manufacturers of conventional compression garments seem to be content with the current situation. They typically do not have to commit to disclosing a full compression curve and do not have to be any more specific concerning a compression garment than to assert that the compression level for a given size, such as a “medium,” will deliver between 20 and 30 mmHg at the most distal portion (fairly wide range) for a given range of circumferences. If the consumer or clinician believes that an off-the-shelf garment will not adequately fit, the manufacturer often has a line of “custom” garments that it is happy to sell to the consumer. Thus, the confusion and limitations of standard fitting charts often lead to the recommendation for a custom fit garment. However, custom fit garments can be cost prohibitive for the user.

Further, even if a consumer or clinician has a compression chart with full compression curves, fitting of compression garments may still be complex. It can be difficult to decide upon on a size and compression class that will meet all specifications of a particular individual. For example, there may be multiple points on a patient where the garment must meet compression specifications. Specifications can require graduated compression values, meaning that compression must vary by a given amount along the length of a limb, for example. Individuals may also have specific characteristics, such as compression sensitivity and varying degrees of lymphedema, which can create even greater complexity in the selection process.

Fitting systems and recommendations may be provided in which compressions are provided for each circumference at key points along a limb. The system can analyze the preferred pressures (or compressions) and circumferences at key points along a limb, such as an arm, and report the best off-the-shelf garment available for the parameters that are input into the program. Embodiment systems also carry out a novel logical flow to determine fit in a simple way, potentially eliminating the need for an expert system user, such as a clinician or therapist. Such a novel logical flow can take into account intended uses of garments as well as patient preferences, sensitivities, etc.

Some embodiments of the present system are configured to provide a best fit in accordance with a principle of graduated compression. For example, the patient or a therapist can specify a level of pressure for a furthermost portion of a patient's limb. The present system may verify that for other portions of the patient's limb that are increasingly close to the body, compression applied by the garment decreases by a given amount.

While the inventive fitting system may place added burdens on the manufacturer (with respect to the more definite specification), the inventive fitting system offers the possibility of a better fitting garment at an off-the-shelf price. Some embodiments make the properties of the compression garment more transparent to the consumer and clinician and allow for better fitting of off-the-shelf garments.

In some embodiments, data processing systems and computer-implemented methods for fitting compression garments include one or more handlers configured to receive measurement(s) of a person's limb and additional information related to a compression need of the person. The system/method may include a recommendation engine that can communicate with the handler, and the engine can calculate an expected compression that a compression garment will apply to the person's limb. The expected compression is based upon the measurement of the limb and upon a known relationship between compression and a garment size. The engine also can determine whether the given compression garment will meet the person's compression needs based upon the expected compression and upon the additional compression need information. The limb can be an arm or leg, for example.

The given compression garment can be pre-made to a standard size. The size can be a circumference, a radius, or a diameter of the garment when it is fitted over an object of a known dimension, such as a cylinder or other rounded surface with a given circumference. Where the limb is an arm, the measurement of the arm can be a circumference of the arm, for example, and the circumference can be at the palm of the hand, wrist, middle-lower arm, or middle-upper arm, for example.

The expected compression can be a first expected compression predicted to be applied to a first portion of the arm, such as a palm, wrist, middle-lower arm, or middle-upper arm, for example. The handler can also be configured to receive from the user a second measurement of the person's arm, a measurement of a palm of a hand connected to the person's arm, or length of the person's arm. The recommendation engine can be configured to calculate a second expected compression predicted to be applied by the given compression garment to a second portion of the arm based upon the second measurement of the arm and upon a second known relationship between a second known compression applied by the given garment and a second size of the given garment. First, second, or other portions of the arm, and corresponding expected compressions, can apply to the wrist, palm, middle-lower arm, or middle-upper arm, for example.

The additional information related to the compression need of the person can be a desired compression, a desired compression class, whether the garment is intended for prophylaxis, a degree of lymphedema or vascular insufficiency of the person, an indication of compression sensitivity of the person, or whether the person has received manual lymph drainage massage, for example. The additional compression need information can also include a combination of these points of information. Where the additional compression need information is a positive indication of compression sensitivity of the person, the expected compression of the given garment can be a lowest expected compression of a set of garments with acceptable expected compression, and the engine can be configured to determine that the garment will meet the compression need of the person based upon the lowest expected compression and upon the positive indication of compression sensitivity.

Determination can be further based upon an expected compression predicted to be applied to the middle-lower arm and/or middle-upper arm of the person. Determination can be based upon a difference between two of the palm, wrist, middle-lower arm, and middle-upper arm expected compressions.

Systems and corresponding methods are not limited to determining suitability of a single compression garment. The recommendation engine can be configured to select a compression garment of a standard size from among two or more pre-made compression garments of different sizes, for example. The selected garment can be selected to meet the compression need of the person, for example.

The recommendation engine can be configured to output any data that are input, calculated, determined, or otherwise available to or used by the system. For example, an expected compression of a compression garment can be output, or a selected garment can be output. Output information can benefit a person intending to wear a compression garment, or the information can assist a clinician, therapist, or other practitioner who works with the person. The recommendation engine can also be configured to calculate an expected palm compression predicted to be applied by a hand garment to the palm based upon the measurement of the palm received by the handler. The hand garment can be a gauntlet, glove, or finger stub glove, for example. Where palm and wrist measurements are received by the handler, and where the expected compression is an expected wrist compression, the recommendation engine can also be configured to deprioritize consideration of the hand garment based upon a difference between the expected palm compression and the expected wrist compression.

The handler and the recommendation engine of the data processing system can be components of a server, a terminal, a desktop computer, a laptop computer, a tablet computer, a handheld computer, a cell phone, or a processor, for example. The system may also include an indicator configured to indicate to the user a location on the arm in which to obtain measurements or a manner in which to obtain the measurement.

In a second embodiment, a computer implemented method of fitting compression garments includes receiving a measurement of a limb of a person. The method also includes calculating an expected compression predicted to be applied by a given compression garment to the limb of the person. The expected compression is based upon the measurement of the limb and upon a known relationship between a known compression applied by the given garment and a size of the garment. The limb can be a leg or arm, for example. The method also includes receiving additional information related to a compression need of the person, as well as determining whether the given garment will meet the compression need of the person. The determination is based upon the expected compression and upon the additional information according to a computer implemented logic flow.

The given compression garment can be a given pre-made compression garment of a predetermined size. The method can further include selecting a pre-made compression garment of a predetermined size from among the given pre-made compression garment of the predetermined size and an additional pre-made compression garment of an additional, respective predetermined size. The garment selected from the two pre-made garments can be selected to be suitable for the compression need of the person.

The additional information related to the compression need of the person can be, for example, a desired compression, a desired compression class, whether the compression need is for prophylaxis, a degree of lymphedema or vascular insufficiency of the person, or an indication of compression sensitivity of the person. Where the additional information is a positive indication of compression sensitivity of the person, the expected compression of the given garment can be a lowest expected compression of a set of garments with acceptable expected compression, and the given garment can be determined to meet the compression need of the person in response to the positive indication of compression sensitivity.

A hand garment can also be selected as part of the method. The hand garment can be a gauntlet, glove, or finger stub glove, for example. The method can further include receiving a measurement of a palm of a hand connected to the arm of the person and calculating an expected palm compression predicted to be applied by the hand garment to the palm based upon the measurement of the palm. The method can include eliminating the hand garment from consideration or deprioritizing consideration of the hand garment based upon a difference between the expected palm compression and the expected wrist compression.

The method can also include receiving and reporting other information. For example, measurements, such as a length of the arm of the person, can be received. The method can include indicating to the user a location on the arm in which to obtain the measurement to be received or a manner in which to obtain the measurement to be received. The method can further include reporting various items of information, such as the expected compression or the selected garment, for example. Elements of example methods according to the embodiment can be performed by a server, a terminal, a desktop computer, a laptop computer, a tablet computer, a handheld computer, a cell phone, or a processor, for example.

In some embodiments, computer program products may be provided. The computer program product(s) may be stored on a non-transitory computer readable medium that includes computer readable instructions that cause one or more processors to receive a measurement of a body part of a person and to calculate an expected compression predicted to be applied by a given compression garment to the body part of the person based upon the measurement of the body part and upon a known relationship between a known compression applied by the given garment and a size of the garment. The computer readable instructions also cause one or more processors to receive additional information related to a compression need of the person and determine whether the given compression garment will meet a compression need of the person. The determination is based upon factoring of the expected compression and upon the additional compression need information to facilitate a recommendation for the person. The determination may also be made according to various factors that facilitate computation of graduated compression.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic diagram of an example computer network environment in which embodiments are deployed.

FIG. 1B is a block diagram of the computer nodes in the network of FIG. 1A.

FIG. 1C is a block diagram showing software and processor detail for the computer nodes in the network of FIG. 1A.

FIG. 2A shows a prior art sizing table based on coarse size ranges.

FIG. 2B shows prior art garment fitting charts that graph relationships between compression applied by compression garments and circumferences for various compression garments and arm locations.

FIG. 2C shows two of the prior art garment fitting charts from FIG. 2B, while further including dots showing patient measurements.

FIGS. 2D-2E show garment fitting charts with improved measurements.

FIG. 2F shows a table implementation of data like those of in FIG. 2E.

FIG. 3 is a flow diagram illustrating a computer implemented method of fitting compression garments according to an embodiment of the invention.

FIG. 4A-4E are flow diagrams illustrating an example flow of information and calculations according to an embodiment computer-implemented method.

FIGS. 5A-5C show example user interface screens according to an embodiment of a data processing system for fitting compression garments.

FIG. 6A illustrates an example hand garment that can be fitted to a patient according to embodiments.

FIG. 6B shows a graph of finger compression versus circumference for an example hand garment.

### DETAILED DESCRIPTION

A description of example embodiments of the invention follows.

### Digital Processing Environments

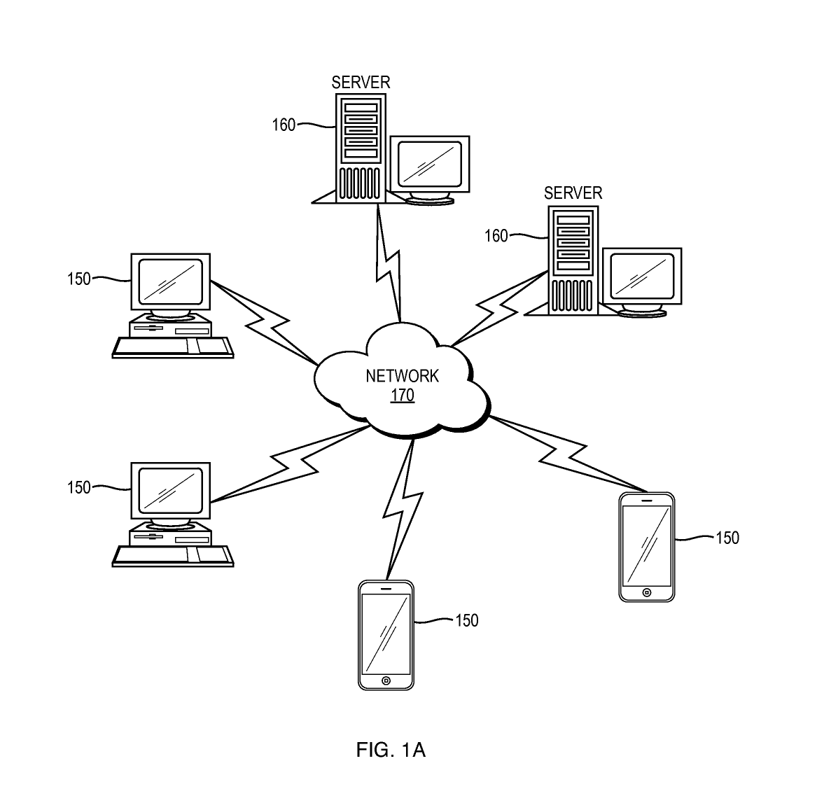

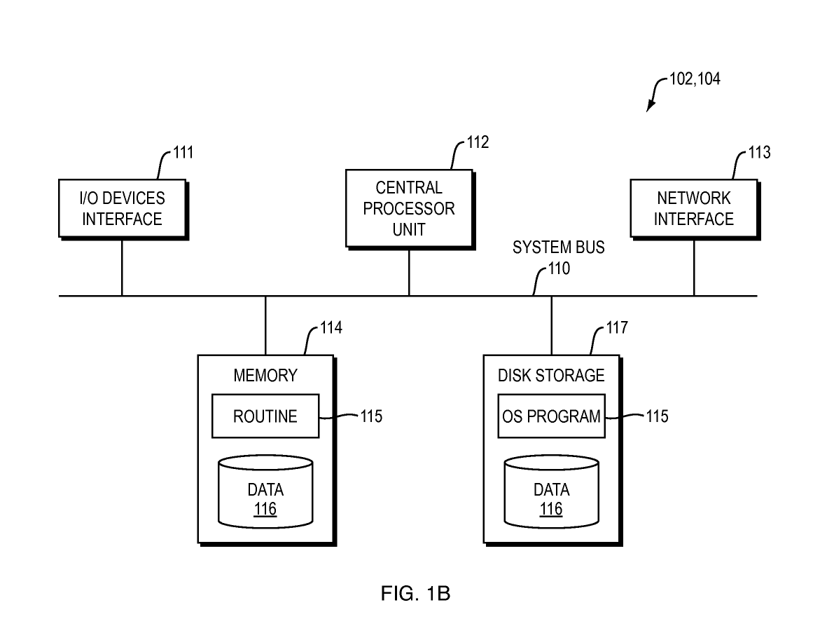

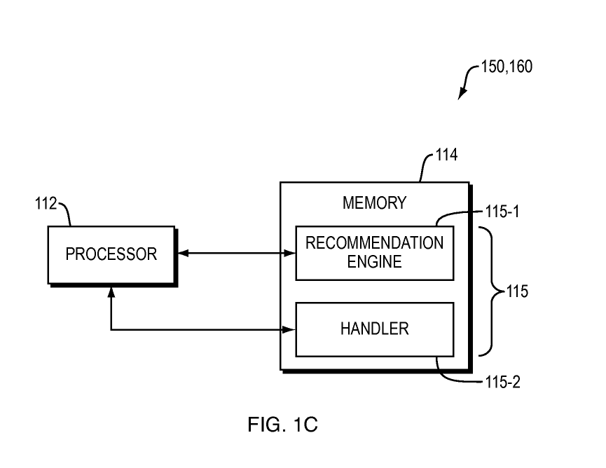

FIG. 1A is a schematic diagram of an example computer network environment in which embodiments are deployed. Example embodiments of a custom compression garment fitting tool may be implemented in a software, firmware, or hardware environment. FIG. 1A illustrates one such environment. Client computer(s)/devices 150 (e.g., computer, mobile phone, tablet computer) and a cloud 160 (or server computer or cluster thereof) provide processing, storage, and input/output devices executing application programs and the like.

Client computer(s)/devices 150 are be linked through communications network 170 to other computing devices, including other client devices/processes 150 and server computer(s) 160. Communications network 170 can be part of a remote access network, a cloud, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

Server computers 160 may be configured to facilitate implementations of embodiments of the custom compression garment fitting tool, for example, which are processed and run at client computer(s)/devices 150. In one example embodiment, one or more of the servers 160 are Java application servers. The Java application servers are scalable, such that if there are spikes in network traffic, the servers can handle the increased load.

FIG. 1B is a block diagram of any internal structure of a computer/computing node (e.g., client processor/device/mobile phone device/tablet 150 or server computers 160) in the processing environment of FIG. 1A. Embodiments of the invention may include means for an internet browser implemented custom compression garment fitting tool. Each computer 150, 160 in FIG. 1B contains a system bus 110, where a bus is a set of actual or virtual hardware lines used for data transfer among the components of a computer or processing system. Bus 110 is essentially a shared conduit that connects different elements of a computer system (e.g., processor, disk storage, memory, input/output ports, etc.) and enables the transfer of data between the elements.

Attached to system bus 110 is an I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 106 of FIG. 1A). Memory 114 provides volatile storage for computer software instructions 115 and data 116 used to implement a software implementation of the custom compression garment fitting tool 115.

The custom compression garment fitting tool 115 described herein may be configured using any known programming language, including any high-level, object-oriented programming language. The custom compression garment fitting tool 115 may include instances of an applet or Flash plug-in, which may be implemented via a software embodiment and may operate within a browser session. The custom compression garment fitting tool 115 may include recommendation engine(s) to facilitate compression computations and garment recommendations based on user input, and one or more event handlers, which may be configured to detect or handle user input and/or passes it to the engine(s) for processing. The engine(s) may be operating from the server or a client system. The handler(s) can be implemented as an event handler, software code that detects data in a form or input field, or receives data; or as a listener, or an input detector, for example.

The custom compression garment fitting tool 115 can be developed, for example, using HTML code, JavaScript and Flash. The HTML code may be configured to embed the custom compression garment fitting tool 115 into a web browsing session at a client 150. The Java Script can be configured to store a measurement of a limb of a patient in a cache and to calculate an expected compression predicted to be applied by a given compression garment to the limb of the person at the client 150. In another embodiment, the custom compression garment fitting engine may be implemented in HTML 5 for client devices 150 that do not have Flash installed.

The custom compression garment fitting tool 115 may be configured to load an XML data file with information and load HTML and/or Javascript event handlers and input forms to request information, such as body measurements from the user.

In an example mobile implementation, a user interface framework for the custom compression garment fitting tool may be based on XHP, Javelin and WURFL. In another example mobile implementation for OS X and iOS operating systems and their respective APIs, Cocoa and Cocoa Touch may be used to implement the custom compression garment fitting tool using Objective-C or any other high-level programming language that adds Smalltalk-style messaging to the C programming language.

Disk storage 117 provides non-volatile storage for computer software instructions 115 (equivalently “OS program”) and data 116 used to implement embodiments of a system for fitting compression clothing of the present invention. Central processor unit 112 is also attached to system bus 110 and provides for the execution of computer instructions.

In one embodiment, the processor routines 115 and data 116 are a computer program product, which implement a custom compression garment fitting tool, including a computer readable medium capable of being stored on the storage device 117 that provides at least a portion of the software instructions for the custom compression garment fitting tool. Instances of the custom compression garment fitting tool and other software embodiments may be implemented as a computer program product 115, and can be installed by any suitable software installation procedure, as is well known in the art. In another embodiment, at least a portion of the custom compression garment fitting tool software instructions may also be downloaded over a cable, communication, and/or wireless connection. In other embodiments, the custom compression garment fitting engine software components may be implemented as a computer program propagated signal product embodied on a propagated signal on a propagation medium (e.g., a radio wave, an infrared wave, a laser wave, a sound wave, or an electrical wave propagated over a global network, such as the Internet, or other network(s)). Such carrier medium or signals provide at least a portion of the software instructions for the present custom compression garment fitting engine invention routines/program 115.

FIG. 1C is a block diagram showing software and processor detail for the computer nodes in the network of FIG. 1A. The processor 112 in nodes 150, 160 may be configured to process compression garment recommendations via an executing recommendation engine 115-1 and handler 115-2, both of which are configured to communicate with the processor 112. The handler 115-2 may be, for example, an event handler configured to be responsive to input from a user or output from the server, or to session management/processing.

As described above in conjunction with FIG. 1B, the handler can be implemented as an event handler, software code that detects data in a form or input field, or receives data; or as a listener, or an input detector, for example. The handler can receive input such as measurements of body parts and additional information about a patient's compression needs from a user, and the handler 115-2 can communicate the information to the processor 112. The processor can then communicate the measurements or information to the recommendation engine 115-1. Thus, in this case, the handler 115-2 and recommendation engine 115-1 are in communication through the processor 112.

As also described above, the recommendation engine 115-1 can facilitate compression computations, and these computations can be based on patient measurements received by the handler 115-2, for example. The recommendation engine can also perform logic operations to determine, based on additional information about a patient's compression need, whether a given compression garment will meet the patient's need. The recommendation engine 115-1 can then communicate compression and garment recommendation information to the processor 112 for reporting to a user interface (not shown).

### Fitting Charts

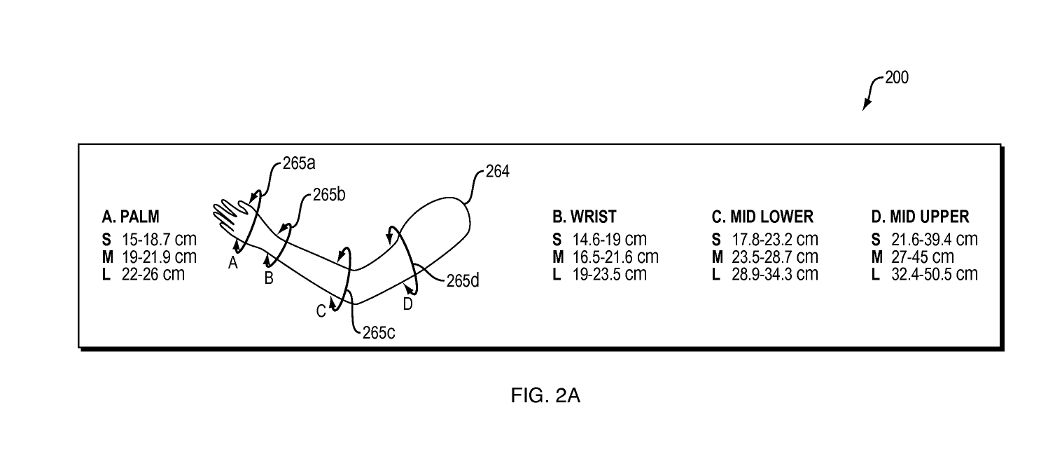

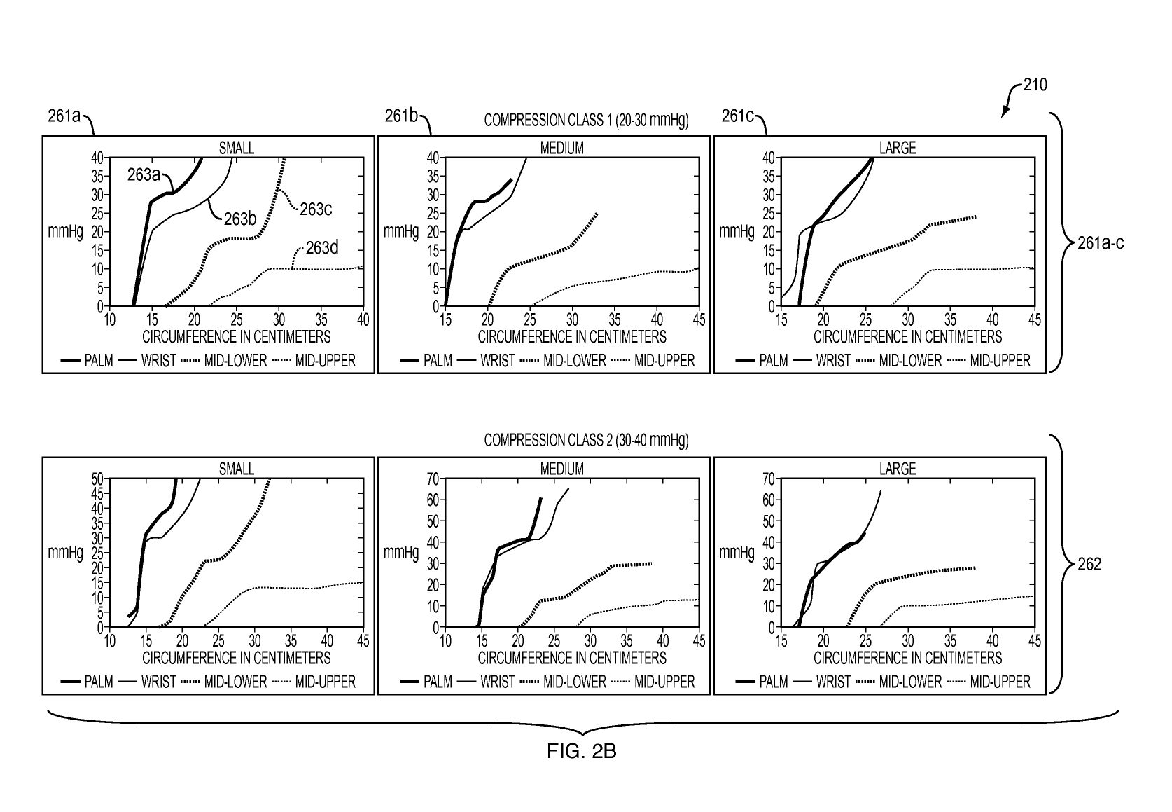

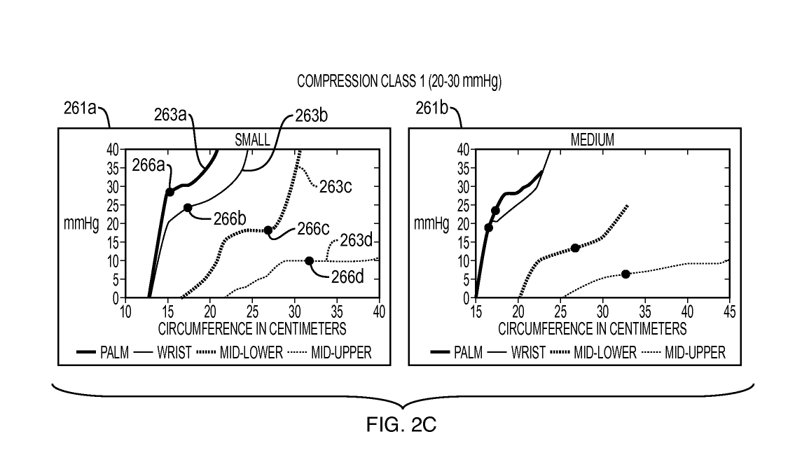

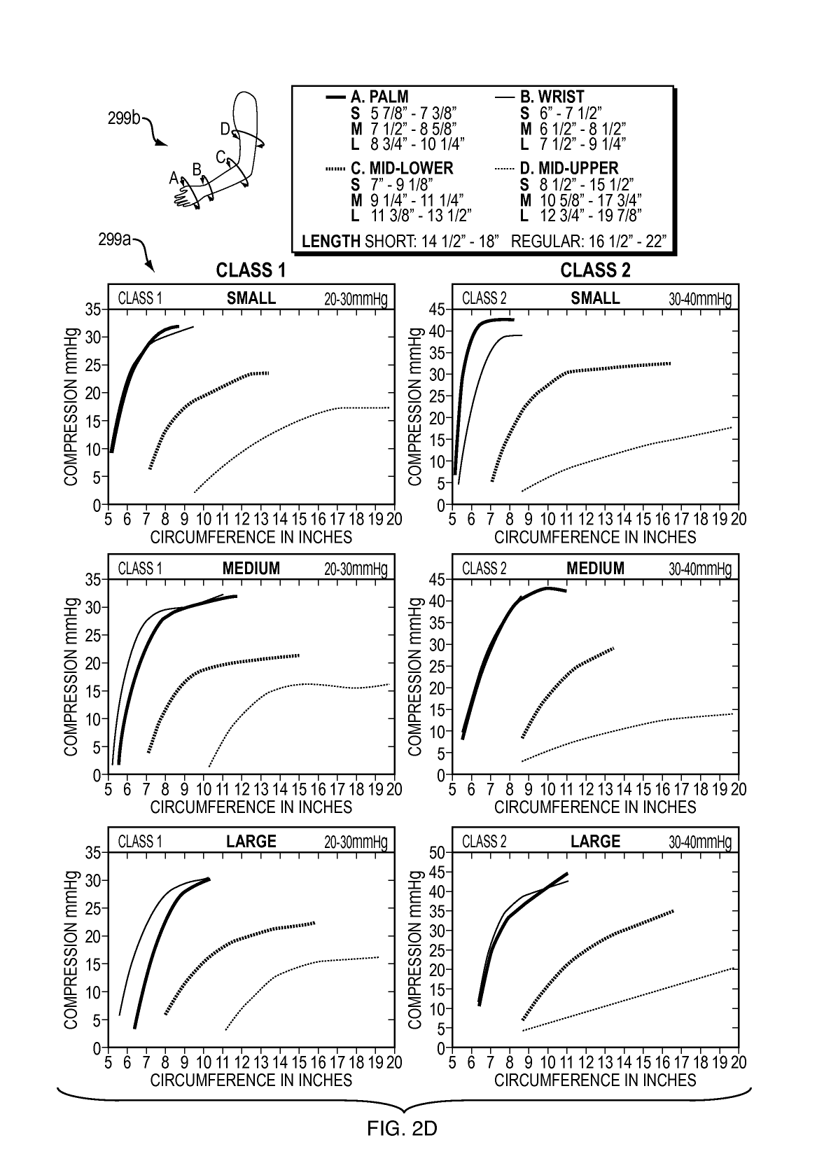

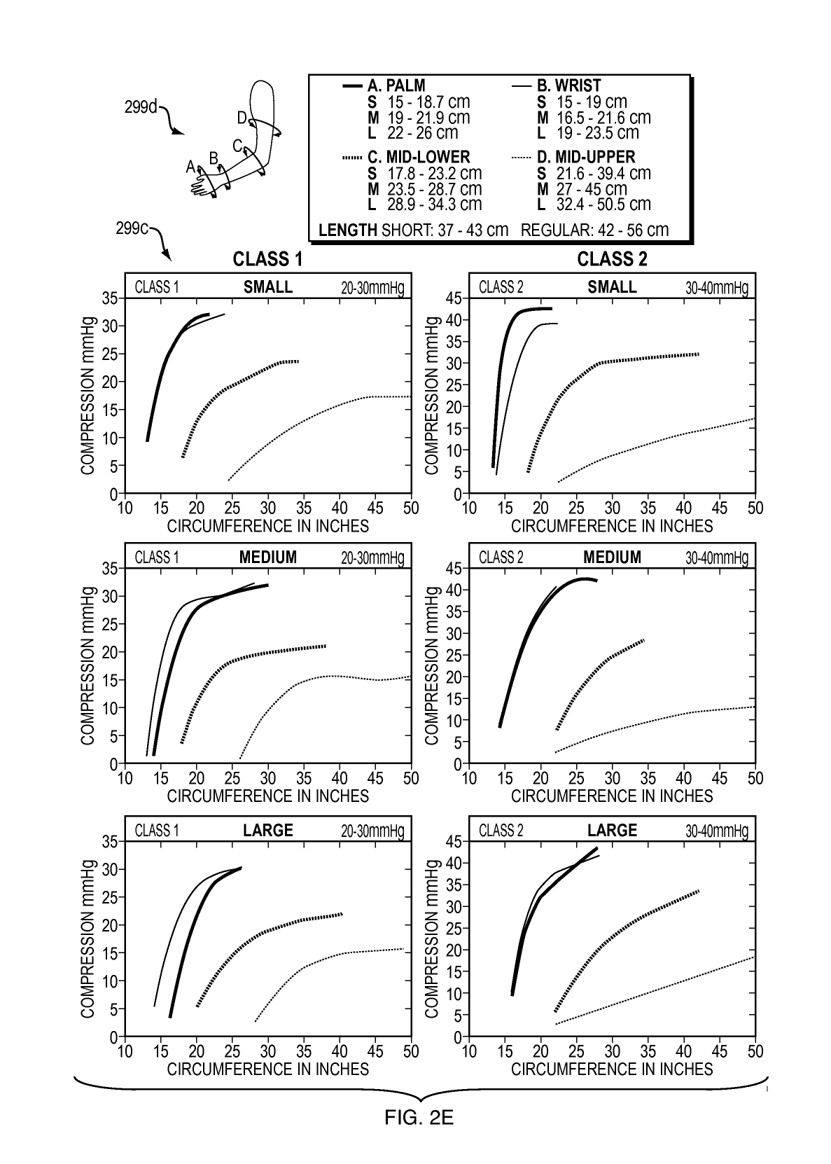

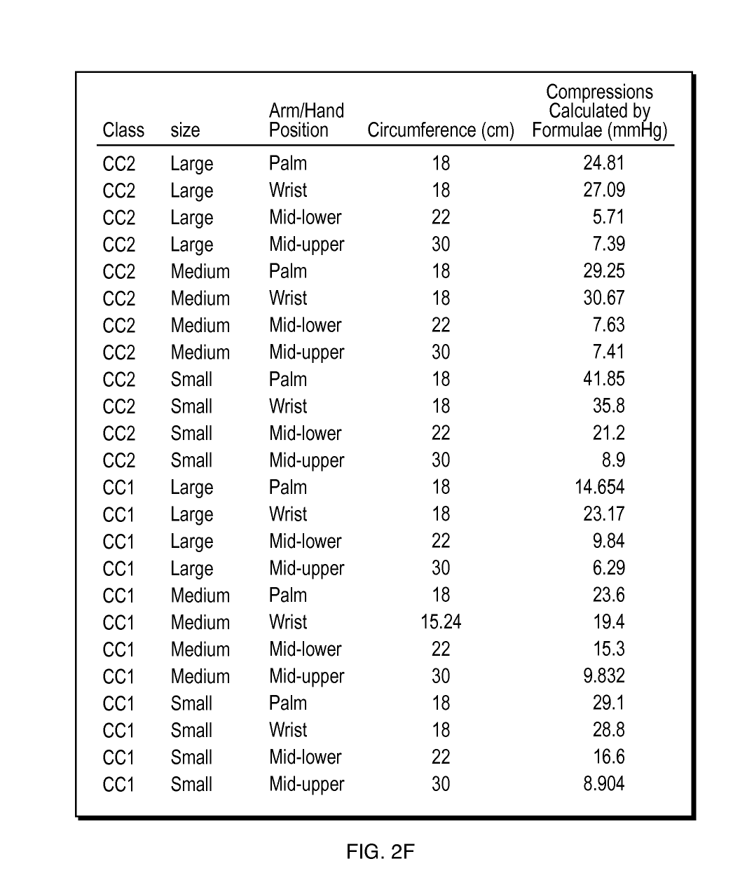

FIG. 2A shows a prior art sizing table 200 for fitting compression garments in small (“S”), medium (“M”), and large (“L”) sizes to a patient's arm 264. Each of the small, medium, and large garment sizes corresponds to a coarse size range for each of the arm locations 265a-d on the patient's arm 264. For given patient measurements, a user may determine whether the patient's measurements fit into the coarse size ranges for each location for a given garment size to determine whether that garment size will provide adequate compression. Sizing table 200 has may suffer from drawbacks as it does not provide compression values, which are the quantities of ultimate interest, and a user cannot determine a specific predicted compression for each circumference value over a range of values.

Ultimately, in certain embodiments, class and size are not the most important characteristics, but rather the specific compression needs required/requested. The output of size/class helps specify purchase needs rather than being for prescriptive determination. The industry standard typically provides size ranges. In the context of certain embodiments of the invention, compression, however, is actually determined by a combination of both the size or dimensions of the garment as well as the size of the arm.

FIG. 2B shows a set of prior art garment fitting charts 210 that graph relationships between compression applied by compression garments and circumferences for various compression garment sizes and arm locations. The set of charts 210 provides information to allow a user to fit a garment based on the different arm locations 265a-d on the patient's arm 264 (shown in FIG. 2A). For example, for the compression class covering 20-30 mmHg, there are charts for small, medium, and large compression garments 261a, 261b, and 261c, respectively. Chart 261a, for example, shows four different curves 263a-d. Curve 263a shows an expected compression predicted to be applied at the patient's palm location 265a as a function of palm circumference; and similarly, curves 263b-d correspond to the patient's wrist location 265b, mid-lower arm location 265c, and mid-upper arm location 265d, respectively.

The fitting charts 210 in FIG. 2B provide more information to the user about the garments than Chart 200 in FIG. 2A. The charts 210 go further by allowing someone to take garment size and arm size together to see what compression the garment is expected to provide at each measurement point for sizing. The circumference-to-compression curves charted in FIG. 2B allow a user to determine a specific predicted compression at any given circumference.

It should be noted that as used in the present disclosure, “size” means any measurement, dimension, or characteristic affecting compression. Thus, for example, size may refer to “small,” “medium,” or “large” garments having a collective set of predetermined dimensions. Size may also refer, for example, to a circumference, a radius, or a diameter of a garment when fitted over an object of known reference dimension such as a hoop or cylinder with a known circumference.

Predicted compression values, however, are preferably determined based upon a stretching cylinder shape, and since patient arms are not perfectly cylindrical, actual realized compression values may vary somewhat from predicted compression values, which may limit the effectiveness of the charts 210.

Based upon measurements of the patient's arm 264 and upon this set of charts 210, a therapist or other user can try to obtain an estimated compression level at the four patient arm locations 265a-d for the small, medium, or large garment, for any circumference in the ranges covered by the charts 210. The estimate compression level may be inaccurate since it is difficult to estimate a size and a compression class that can meet the specifications of a particular individual. Nevertheless, using the charts 210, the therapist can determine whether a given garment of the given size will apply the requisite pressure at each of the four arm locations 265a-d shown in FIG. 2A.

The compression versus size considerations illustrated by FIGS. 2A and 2B can be applied to other body parts beside arms, such as legs and fingers. In the case of fingers, for example, a hand garment such as a glove, gauntlet, or finger stub glove can be configured to provide compression to fingers, and charts such as those of FIGS. 2A and 2B can include expected compression levels based on finger circumference or other finger dimensions.

FIG. 2C shows two of the prior art garment fitting charts from FIG. 2B, while further including dots 266a-d representing patient arm measurements for a particular patient. The patient's arm measurements are used in an example in the following section to further illustrate example potential deficiencies of conventional manual fitting methods, such as those employing the table 200 and charts 210.

A specific example of manual use of table 200 and fitting charts 210 (shown in FIGS. 2A-2C) for the subject patient helps illustrate example deficiencies of manual fitting. The subject patient's arm measurements 266a-d are shown in FIG. 2C, and in this example, the patient requires a Class 1 sleeve. The measurements 266a-d are, respectively, palm 17 cm, wrist 16.5 cm, mid-lower 27 cm, and mid-upper 32 cm.

As can be seen from FIG. 2A, the patient's wrist size is compatible with both the small and medium garment sizes. The patient's mid-lower measurement, however, clearly requires the medium garment. The mid-upper measurement could be covered by any of the three garment sizes in the table 200. Thus, based on the coarse size ranges given in table 200, only the medium garment would meet compression specifications at all four arm locations 265a-d.

One fitting complexity appreciated and addressed by certain embodiments herein is that in most cases, it is desirable to have graduated (or differential) pressure (for applied pressure to decrease for arm locations closer to the patient's body). For example, the greatest pressure is typically required at the palm, and successively smaller pressures may be required at wrist, mid-lower arm and mid-upper arm locations. An example pressure specification for a patient may require an applied pressure that is at least 5 mmHg lower at the mid-lower arm than at the wrist, for example. However, based on table 200, it would be somewhat difficult or impossible to determine whether graduated pressure requirements are met, because specific predicted compressions are not available in table 200.

Additional information about the patient's needs may be useful because size compatibility is ambiguous for at least the wrist and mid-upper measurements. However, even if additional information is available, table 200 has no indication of how to use it, nor a logical decision process for determining how to use the additional information, nor would this determine compatibility with graduated compression requirements based on the information available in table 200.

As an alternative to using table 200, a user may use charts 210, which provide some advantages over table 200. To use chart 210, the user begins by sizing the sleeve, first evaluating the “small” sleeve based using the Class 1 “small” chart 261a. To determine the pressure at the wrist, the user places the tip of the pen just above the paper at the arrow and follows the base of the chart to 16.5 and then moves straight up to the red wrist line and marks the point where 16.5 meets the wrist line with a dot. This shows that the predicted pressure at the wrist is 24 mmHg. The user repeats this process to determine the predicted pressure or compression at the mid-lower and mid-upper arm positions. This yields 24 mmHg at the wrist, 17 mmHg at the mid-lower arm, and 10 mmHg at the mid-upper arm.

For graduated compression, each dot should usually be at least 5 mmHg below the previous dot. In the example case, a small sleeve may satisfy the criteria for a good fit with the compression near the middle of the 20-30 mmHg range. With enough analysis, a therapist, for example, may be able to determine whether graduated compressions requirements can be met.

A similar analysis for the medium sleeve can be done. When the analysis is completed, the user sees that the compression at the wrist is 18 mmHg and pressure at the mid-lower arm is 15 mmHg. There are two concerns here: first, the medium size sleeve does not provide enough compression at the wrist; and second, the pressure difference between the wrist and mid-lower arm is only 4 mmHg for the medium sleeve, which does not meet a 5 mmHg graduated compression standard. Thus, manual analysis based on the charts 210, without additional information about the patient's needs or logical analysis on how to process this information, may lead to a conclusion that the small sleeve, and only the small sleeve, will meet the patient's needs.

The fitting determination based on the table 200 or charts 210 becomes increasingly complex and impossible for some to accurately complete manually due to the number of measurements and predicted compressions, as well as the graduated compression that is typically not considered. Furthermore, the table 200 and charts 210 do not provide a logic flow for decision making and do not take into account other information regarding compression needs that may be part of a complete fitting analysis.

FIG. 2D shows garment fitting charts 299a with circumference-to-compression curves similar to the charts 210 in FIG. 2B. However, the charts 299a differ from those of FIG. 2B because charts 299a include more accurate compression measurements made using a Salzmann Model MST MK4 compression measurement device. The charts 299a include compression measurements for four different garment positions, palm, wrist, mid-lower arm, and mid-upper arm, for each of three sizes small, medium, and large, for each of compression Classes 1 and 2. FIG. 2D also includes a course sizing chart 299b similar to the chart 200 of FIG. 2A.

FIG. 2E shows garment fitting charts 299c and course sizing chart 299d similar to charts 299a and 299b, respectively. A difference is that charts 299c-d are shown in circumference units of centimeters (cm), while the charts 299a-b are in inches (″).

The curves of FIGS. 2D and 2E were derived experimentally on a Salzmann MSK-IV compression-testing device and then fitted to algebraic functions (formulae). The formulae are mathematically equivalent to the shapes of the curves in FIGS. 2D and 2E. In computer implementations, a computer can store the formulae representing the curves of FIGS. 2D and 2E and can calculate a compression for each given circumference for a given garment. The inventive recommendation tool/engine 115 may use the formulae to generate the compression level for the circumference entered into the tool/engine 115.

FIG. 2F shows compression values used to derive the formulas shown in FIG. 2E. As stated above, the compression values were obtained experimentally using a Salzmann MSK-IV compression-testing device and then fitted to algebraic functions to determine the formulae shown in FIG. 2E. After the formulae are determined, they can be stored in a computer, which can then calculate a compression for each known compression class, garment size, arm or hand position, and arm or hand circumference. The compression values in the rightmost column of FIG. 2F are also the same compression values output from the computer based on the formulae representing the function-fitted data. Thus, for each circumference from the circumference column of FIG. 2F that is entered into the computer, the corresponding compression level from the rightmost column can be returned.

### Compression Need Information

The inventors have discovered, among other things, that additional compression need information about a patient's compression needs may not only be used, but may be incorporated into a logical decision process. A data processing system for fitting compression garments can help a therapist make a decision by estimating pressures at the wrist, mid-lower, and mid-upper arm, as well as other locations, such as the palm. Moreover, better fitting determinations can be made than those based upon the charts alone by also basing determinations on the additional compression need information, in addition to the patient's measurements and the predicted garment compressions.

As one example of additional compression need information, the system 115 may consider whether or not the garment is intended for prophylaxis, and whether the wearer is very sensitive to compression, can help impact garment suitability. In the manual example above based on fitting using the conventional charts 210, the medium sized sleeve did not provide enough compression at the wrist, and the graduated compression was slightly too small. However, if the garment is for prevention and the wearer is very sensitive to compression, a medium garment, with lower compression, could be a good compromise. On the other hand, the small garment may still be a better option for mild to moderate lymphedema if the patient is not sensitive to compression. Similarly, other considerations of patient needs can help determine fit in accordance with a logical process flow that the inventors have discovered. A data processing system for fitting compression garments can be provided, which incorporates patient compression needs, and may facilitate recommendations of a better fitting compression garment for patient arms, particularly for those that measure between sizes.

The set 210 of charts, or the compression versus circumference information underlying them, may be used as part of a data processing system for fitting compression garments. A therapist can determine what compression is needed for a patient. The needed compression may fall into one of two categories: Class 1 (20-30 mmHg) or Class 2 (30-40 mmHg). In other embodiments, however, the compression requirements are different and the compression ranges can apply to body parts other than the arm, such as a leg or torso. For example, in one embodiment, relevant compression ranges include 15-23 mmHg and 40-50 mmHg.

Preventive patients need minimal compression, and comfort level may be given more emphasis than compression level to convince preventive patients to comply with orders to wear the garment. In addition, there is typically a 5 mmHg differential between the measurement points. In other embodiments, graduated compression requirements may be 4.5 mmHg or other values, and an example maximum differential is 10 mmHg, for example. Further, patients with preventive needs may not require 5 mmHg or even 4.5 mmHg differentials.

As used in the present disclosure, “user” signifies any person using fitting tools, such as fitting charts or other fitting data. For example, users may include clinicians, doctors, therapists, nurses, or in some cases even patients or consumers for whom the garment is intended. In some cases, a clinician, doctor, or therapist provides recommendations or patient need information, and a “user” inputs the recommendations/information into a computer or otherwise uses the recommendations/information to help select a compression garment.

Further, as used in this application, “person” may refer to any individual with a need or desire for a compression garment. For example, a person may be a patient, consumer, and/or a recipient of therapy.

### Example Custom Fitting Processes

In accordance with some embodiments, computational devices, such as mobile devices, including cell phones and tablets, may be used to implement and improve usability of the use of custom compression garment fitting tool 115. Analog charts may require some technical acumen and may be intended primarily for the clinician to fit a patient. Using the custom compression garment fitting as a mobile application, can help eliminate the complexities involved in trying to comprehend the graph and also allow additional expert knowledge to be incorporated into a novel logical flow to individualize the selection of the garment. With these developments, the usability of the compression garment fitting tool/process 115 can be augmented to a point that even a patient/consumer could select and purchase an appropriate compression garment.

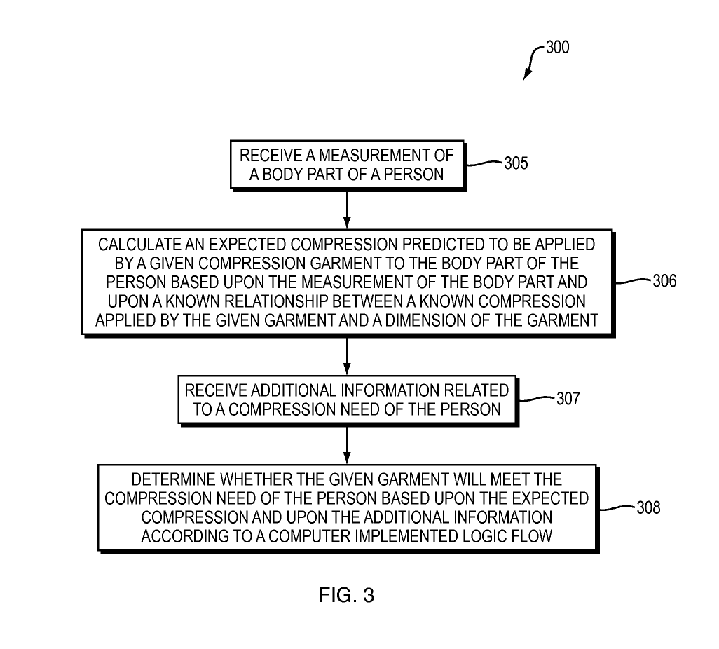

FIG. 3 is a flow diagram illustrating a computer-implemented method 300 of fitting compression garments according to an embodiment of the invention. At 305, a measurement of an arm of a person is received. At 306, an expected compression is calculated. The expected compression is predicted to be applied by a given compression garment to the arm of the person based upon the measurement of the arm and upon a known relationship between a known compression applied by the given garment and an additional characteristic of the garment. At 307, additional information related to a compression need of the person is received. At 308, a determination is made about whether the given garment will meet a compression need of the person. The determination is based upon the expected compression and also upon the additional compression need information according to a computer implemented logic flow.

The interaction between a computer/software interface and a user is preferably characterized by simplicity and speed. Embodiments enable a user to enter the measurements quickly, indicate what type of compression class is needed, and then enter a scale for the level of need (preventive, mild/moderate, severe). Once these items of information are entered, embodiment user interfaces report any recommendations, such as size or class or other information. Reporting may be in the form of printed papers, a screen display, audio information, or memory/data storage media, etc., for example.

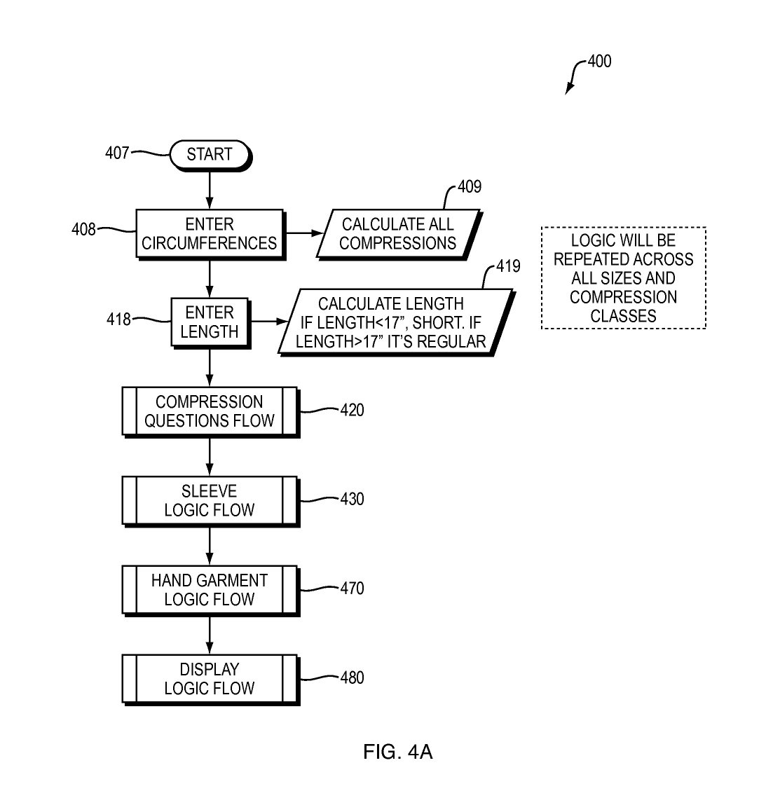

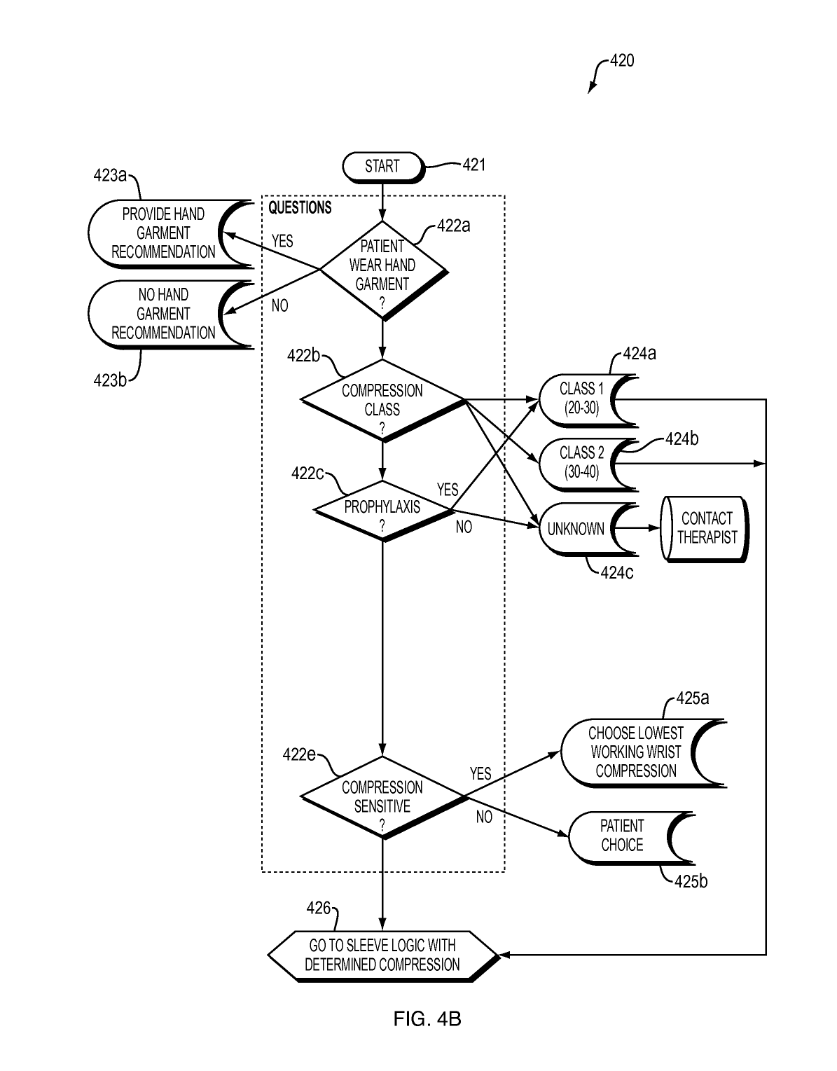

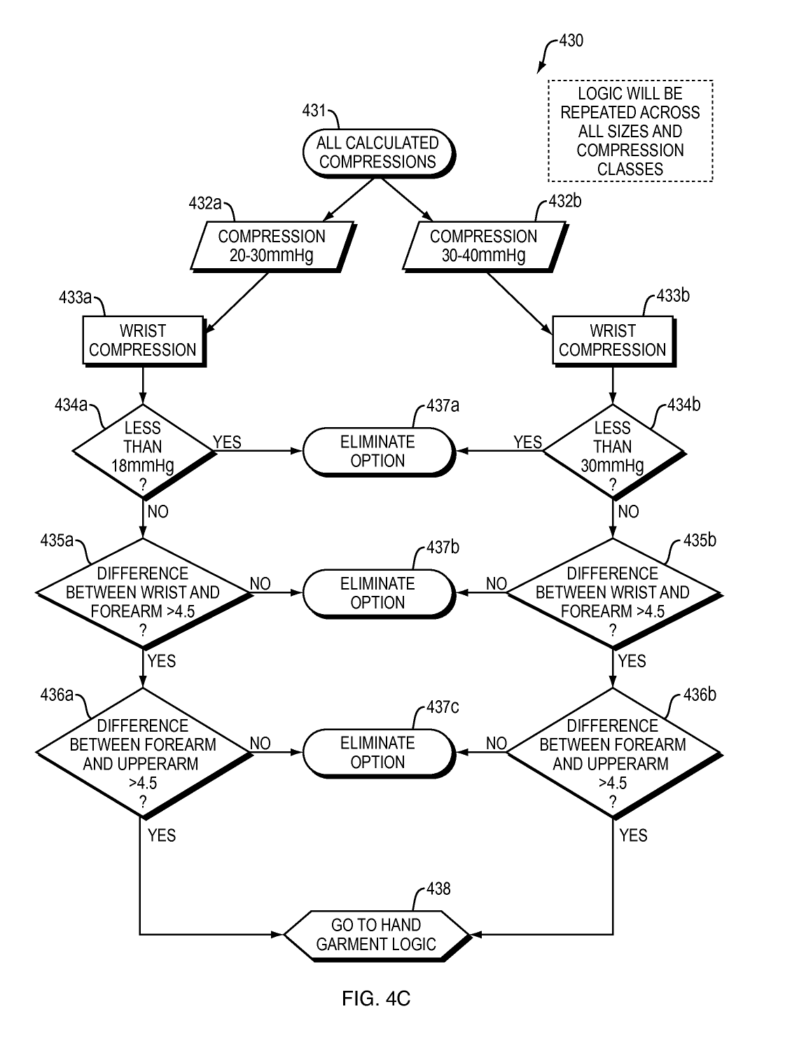

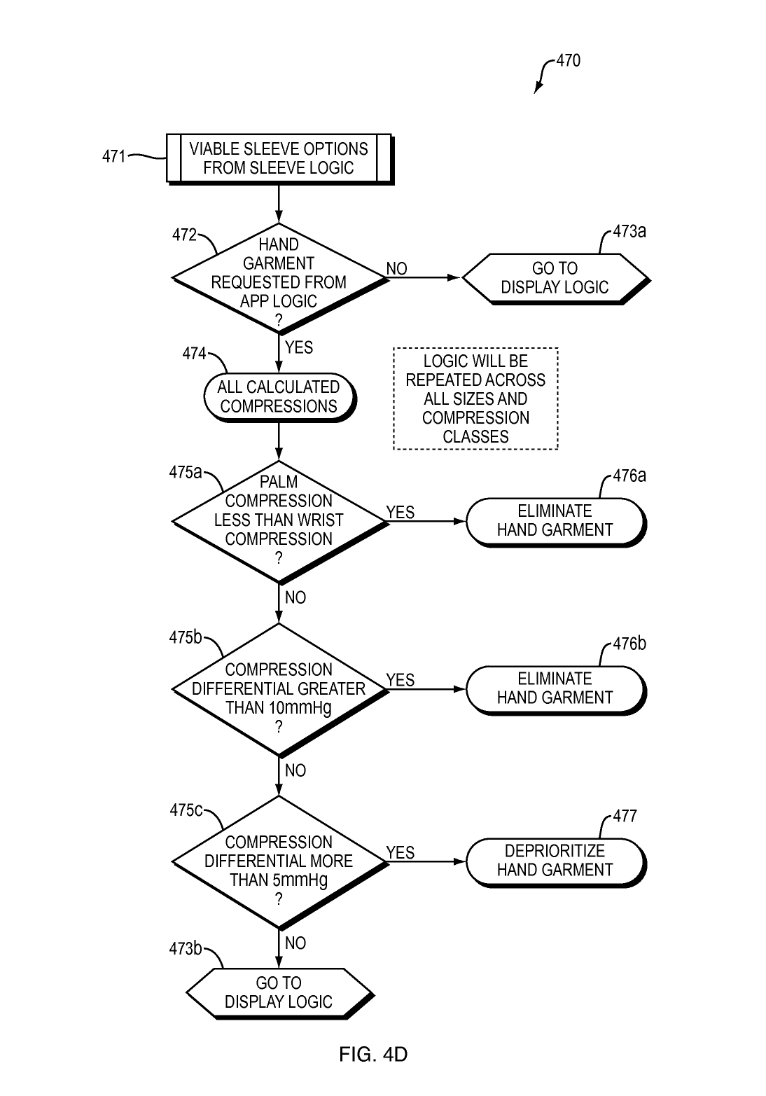

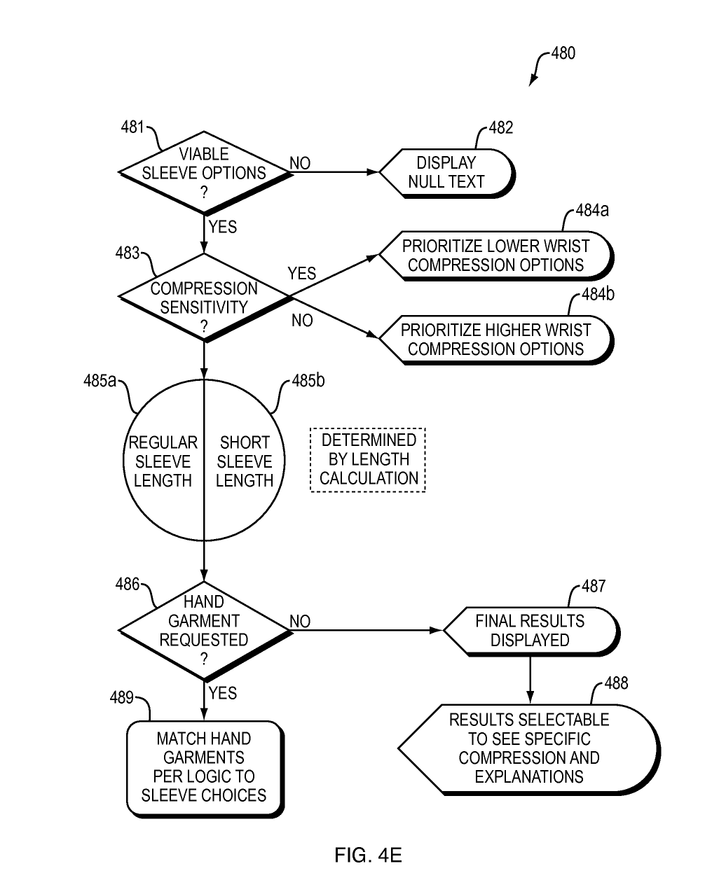

FIG. 4A-4E are flow diagrams illustrating example computational processing of information and calculations according to an embodiment computer-implemented method 400.

FIG. 4A is a top-level overview of the embodiment method 400. At 407, the process starts. The software shows an animated arm diagram, which is not shown in FIG. 4A but is similar to arm 264 in FIG. 2A. The animated arm indicates to a clinician where to measure the patient's arm. The software also gives the clinician the opportunity to select measurement units of cm or inches (not shown). At 408, the clinician enters circumferences of a patient's arm into the computer. The circumference locations include palm, wrist (over the “bump” or ulnar styloid process), forearm (thick part), and upper arm (below arm pit, around bicep). At 409, compressions are calculated based on the measured circumferences and on compression-circumference curves, similar to those of FIGS. 2A and 2B, which are stored as formulae in computer memory. This results in one compression value per hand garment (corresponding to palm measurement) and three compression values per sleeve (corresponding to the other three measured circumferences. In other embodiments, only one measurement and compression value are applicable to a sleeve. In yet other embodiments, additional compressions are calculated from measurements and predicted to be applied to other parts of the arm, hand, or fingers, for example.

At 418, the clinician enters the length of the patient's arm. At 419, the measured arm length is used to determine whether the length is a regular (length >17″) or short (<17″). In other embodiments, there is only one length from which to choose. In yet other embodiments, there are more than two lengths from which to choose, corresponding to more than two length categories. At 420, the computer and the clinician engage in a compression questions flow, as further detailed in FIG. 4B. At 430, a sleeve logic flow is carried out, as shown in FIG. 4C. At 470, a hand garment logic flow is carried out, as shown in FIG. 4D. At 480, a display logic flow is completed, as detailed further in FIG. 4E.

FIG. 4B shows a compression questions flow chart according to an embodiment computer-implemented method. At 421, the process starts. At 422a, a clinician is asked whether the patient will wear a hand garment. If the answer is yes, then at 423a, the computer produces a hand garment recommendation. If the answer is no, then at 423b, the computer does not recommend a hand garment.

At 422b, the clinician enters a compression class recommended for the patient. The clinician may enter (i) (Class 1, 20-30 mmHg) or (ii) (Class 2, 30-40 mmHg). At 422c, the clinician also specifies whether the garment is for prophylaxis. If the answer to the prophylaxis question is yes, then at 424a, Class 1 is chosen. However, if the answer to the prophylaxis question is no, then at 424c, the unknown class is chosen, and the system 115 may recommend that the user seek the support of a therapist to make a selection.

At 422e, the clinician answers whether the patient is compression sensitive. If the answer is yes, then at 425a, the lowest working wrist compression is selected. If the answer is no, then at 425b, then at 425b, the patient is given a choice of compression level. At 426, the process continues to the sleeve logic with the determined compression.

FIG. 4C shows a sleeve logic flow 430 according to an embodiment computer-implemented method. According to sleeve logic flow 430, sleeves with a wrist compression less than the appropriate range for the chosen class are eliminated as options. Further, sleeves for which compression differentials are not greater than 5 mm Hg are eliminated as options. If no sleeve options remain meeting the pressure and differential requirements, then the user is given a message “Sorry! Patient will not receive adequate or appropriate compression based on their measurements.”

At 431, the process begins with the compressions calculated at 409 in FIG. 4A. At 432a, if the compression class chosen is Class 1 (20-30 mmHg), then the logic proceeds to 433a. At 432b, if the compression class chosen is Class 2 (30-40 mmHg) is used. At 433a and 433b, a compression predicted for the patient's wrist location is evaluated. At 434a and 434b, if the predicted compression at the wrist is lower than the minimum for the desired compression range, then at 437a, the sleeve option being evaluated is eliminated. At 435a and 435b, if a difference between predicted compressions for the wrist and forearm locations is not greater than 4.5 mmHg, then at 437b, the sleeve option is eliminated; otherwise, the logic flow proceeds to 436a or 436b, respectively. At 436a and 436b, if the difference between predicted compressions for the forearm and upper arm locations is greater than 4.5 mmHg, then at 437c, the sleeve option being evaluated is eliminated; otherwise, the process proceeds to 438. The sleeve logic flow 430 is similarly repeated (not shown) for each remaining sleeve option. In other embodiments, if no viable sleeve options remain at this point, then a message is given to the user indicating that fact. At 438, the process proceeds to the hand garment logic flow according to FIG. 4D.

FIG. 4D shows a hand garment logic flow 470 according to an embodiment computer-implemented method. Hand garment logic flow 470 eliminates unsuitable hand garment options, where a hand garment has been requested at 422a in FIG. 4B.

At 471, the hand garment logic flow begins with the remaining viable sleeve options from the sleeve logic 430. At 472, if a hand garment was previously requested, the hand garment logic flow proceeds to 474; however, if a hand garment was not requested, then at 473a, the display logic according to FIG. 4E is triggered. At 474, the calculated compressions are available to be used. At 475a, if the palm compression is less than the wrist compression, then at 476a, the hand garment being evaluated is eliminated as an option. At 475b, if the compression at the palm is greater than 10 mmHg more than at the wrist, then at 476b, the hand garment being evaluated is eliminated as an option. At 475c, if the compression differential is greater than 5 mmHg, then at 477, that particular hand garment option is deprioritized. This logic is repeated (not shown) for each remaining sleeve option. At 473b, the process proceeds to the display logic according to FIG. 4E. The logic according to 470 is repeated for all sizes and compression classes.

FIG. 4E shows a display logic flow 480 according to an embodiment computer-implemented method. At 481, if there are not any remaining viable sleeve options, then at 482, the clinician receives a null text message; otherwise, the logic flow proceeds to 483. At 483, if the patient is compression sensitive, then at 484a, any garment options with lower wrist compression are prioritized. However, if the patient is not compression sensitive, then at 484b, higher-compression options are prioritized.

At 485a and 485b, the length calculation from 419 in FIG. 4A is used to determine sleeve size (regular sleeve for length ≧17″; short sleeve for length <17″). At 486, if a hand garment has not been requested, then at 487, final results for viable compression garment options are displayed to the clinician, and then at 488, the clinician is given the choice to select a particular garment option and see specific compression values that the particular garment is predicted to apply to the patient at various arm locations with any accompanying explanations. Further at 486, if a hand garment has been selected, then at 489, viable hand garment options are matched to viable sleeve options prior to displaying results and allowing their selection at 487 and 488, respectively.

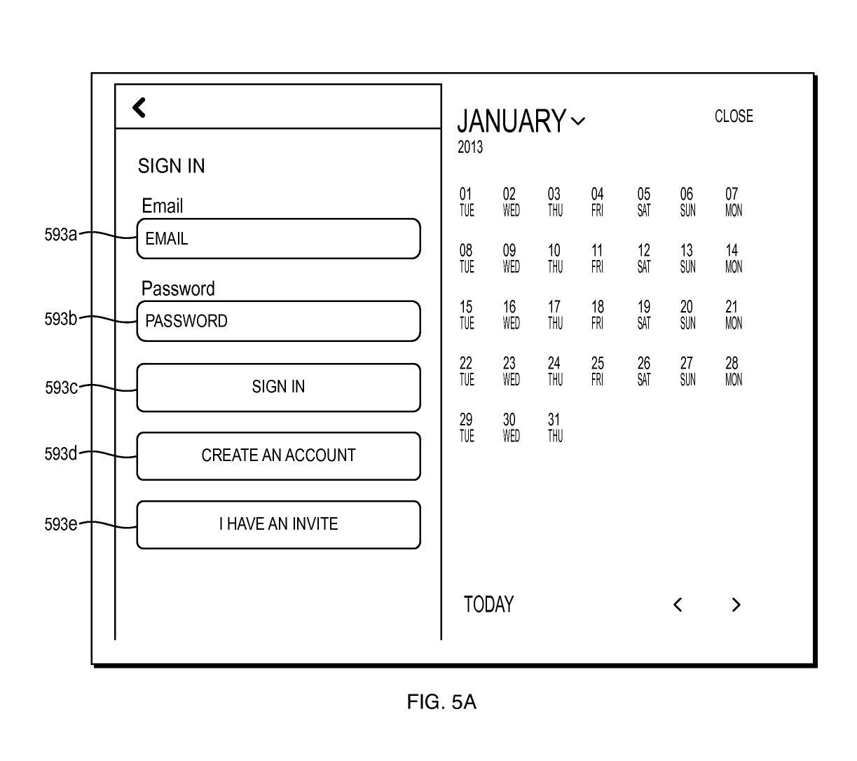

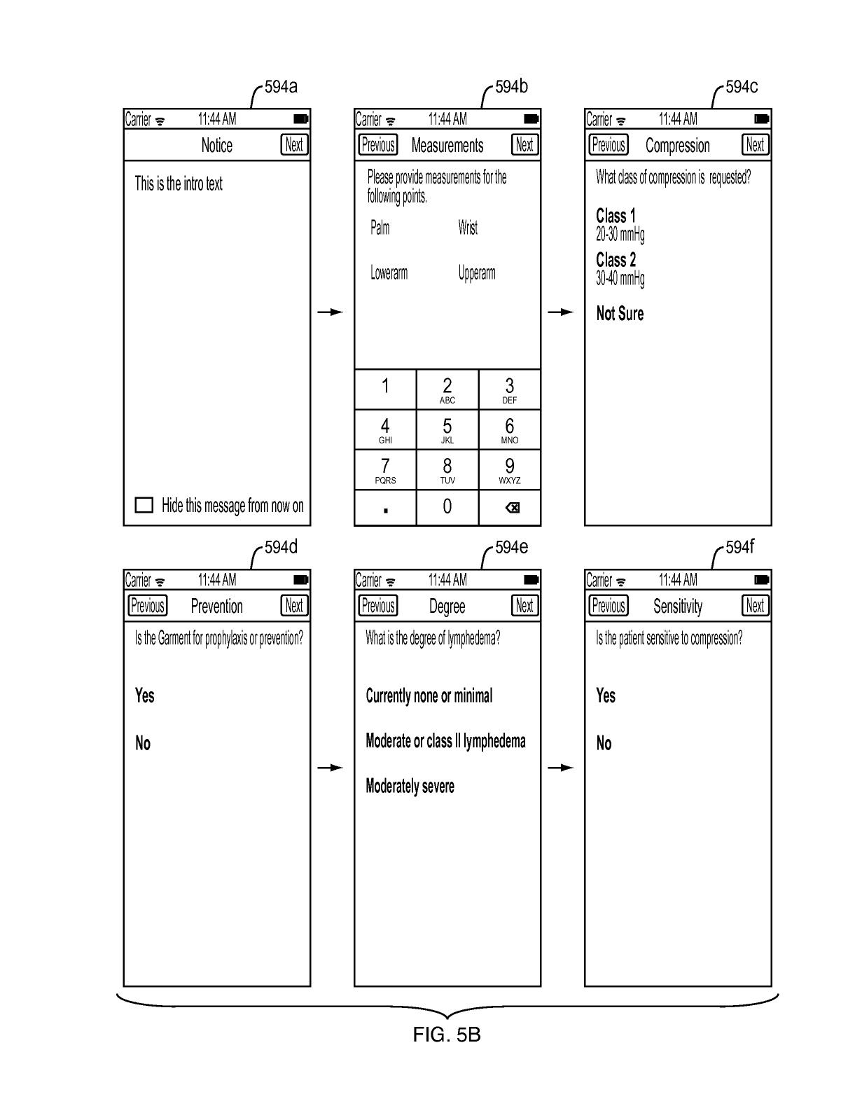

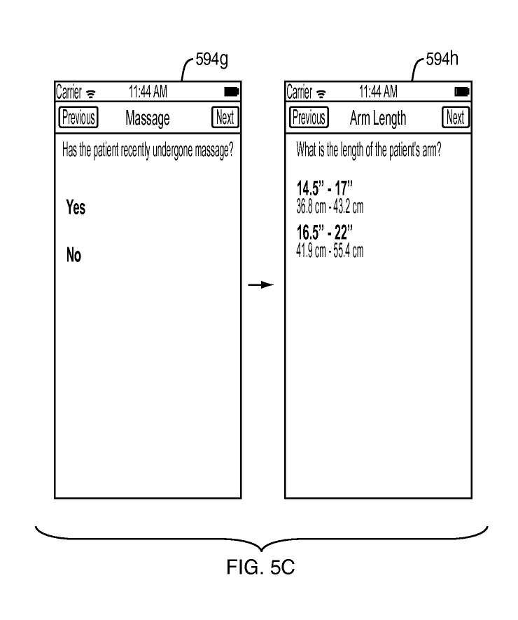

FIGS. 5A-5C show example user interface screens for an example data processing system for fitting compression garments.

FIG. 5A shows an example user interface login screen. An <Email> field 593a and a <Password> field 593b allow a user, such as a clinician, to sign in to the system using stored credentials. The system can store Email and Password credentials to customize settings, for example, for each user. A <Sign In> button 593c can be pressed by the user trigger the system to check credentials and allow access to the software. A <Create an Account> button 593d allows a new user to create a new account with unique sign-in credentials. An <I Have an Invite> button 593e may be used to allow a user to have access to closed portions or versions of the system. By storing user credentials, the system can provide customized compression garment recommendation for each user account.

FIG. 5B shows an introduction screen 594a, where a variety of introductory messages can be displayed to the user. A measurement screen 594b allows the user to input patient measurements, including a palm circumference, wrist circumference, mid-lower (forearm) circumference, and mid-upper (upper arm) circumference. Some embodiments further specify the wrist circumference as being over the “bump” or ulnar styloid process, and some embodiments specify that the forearm circumference is to be measured at a thick part of the forearm. Some embodiments specify that the upper arm circumference is to be measured below the arm pit. Some embodiments further allow the user to input other body part measurements such as finger circumferences, and these circumferences can be used to determine expected compression levels predicted to be applied by a given garment to the patient's fingers by a hand garment such as a glove.

The measurement screen 594b includes a keypad for entering measurements. A compression screen 594c allows the user to input the required compression class, if known, including Class 1, Class 2, or “Not Sure.” In this embodiment, the answer input at this screen, if Class 1 or Class 2, will define the compression class, no matter what other answers may be given by the user.

A prevention screen 594d allows the user to specify whether the compression garment is intended for prophylaxis. If the user specified that the compression class was unknown, and the user specifies that the garment is for prophylaxis, then the software will choose compression Class 1 as an option. A degree screen 594e allows a user to specify a degree of lymphedema experienced by the patient, including none/minimal, moderate/Class 2 lymphedema, or moderately severe. A sensitivity screen 594f allows a user to specify whether the patient is sensitive to compression. If the user specified that the compression class was unknown, and the user specifies that the garment is not for prophylaxis, yet the patient is sensitive to compression, then the software will choose compression Class 1 as an option. Further, if the compression class is unknown and neither prophylaxis nor sensitivity is indicated by the user, then compression Class 2 will be chosen by the software.

FIG. 5C includes a massage screen 594g and an arm length screen 594h. The massage screen 594g allows a user to specify whether the patient has recently undergone a massage. The arm length screen 594h allows a user to specify the length measurement of the patient's arm, including a regular length 16.5″ to 22″ and a short length 14.5″ to 17″.

### Example Implementations

In an example embodiment computer implementation, the software 115 can be configured to determine whether a given compression garment will meet a compression need of the person. A best off-the-shelf garment selection to meet the need of the person can be determined. These determinations can be based upon the expected compression and upon additional information related to the compression need of the patient according to a computer implemented logic flow including the following:

Input Data. A cell phone app, for example, may be configured to receive user input. A computer handler may be configured to detect the entered data. The computer program may be configured to provide a diagram or animation showing a simulation as to where measurements are to be taken on the patient. The diagram, for example, may be similar to the arm 264 and accompanying measurement locations 265a-d in FIG. 2A. The cell phone software may provide the user with an opportunity to select measurement units of centimeters or inches. The software may then prompt the user to input information about the following data for the patient's arm:
a) Palm circumference
b) Wrist circumference (over the “bump” or ulnar styloid process)
c) Forearm circumference (over the thick part of the forearm)
d) Upper arm circumference (below the armpit)
e) Arm length.

Queries. The following queries a)-e) may be processed by the cell phone software in order to receive related input from the user:
a) Will the patient wear a hand garment?
   i. Yes.
   ii. No.
b) What class of compression is required? (The answer to this question, if known, defines the compression class, no matter what other answers are given.)
   i. Class I 20-30 mmHg.
   ii. Class 2 30-40 mmHg.
   iii. Don't know (See therapist).
c) Is the Garment for prophylaxis (prevention)?
   i. Yes (The lowest working compression at the wrist is chosen).
   ii. No (The highest working compression at the wrist is chosen).
d) Is the patient sensitive to compression?
   i. Yes (The lowest working compression at the wrist is chosen).
   ii. No (The highest working compression at the wrist is chosen).
e) Length of arm
   i. 14.5″-17″ (36.8 cm-43.2 cm) (short length).
   ii. 16.5″-22″ (41.9 cm-55.9 cm) (regular length).

Overall Logical Flow. According to a logic flow, i) all calculations are run; ii) garment options for which expected wrist compression is less than 18 mmHg are eliminated; and iii) a compression class is derived.

Logical Flow Examples with Psuedo Code. According to a detailed logic flow for an example cell phone application:
a) Each measured circumference is converted to a pressure in mmHg by accessing a specific formula that returns a compression value in mmHg. The curves are similar to the set 210 of curves shown in FIG. 2B. The calculated pressures are stored in a table. This results in one pressure value per hand garment and three pressure values for each sleeve.
b) Sleeves with wrist pressures that are too low or lengths that are incompatible with the patient's measurements are eliminated from consideration. Sleeves associated with wrist pressures less than 18 mmHg are eliminated. (Sleeve lengths include Regular and Short; sleeve circumferences include Small, Medium, and Large; and Compression Classes include Class 1 and Class 2). Eliminated sleeves have too low a pressure for US applications.
   i. Short corresponds to question e), Option i).
   ii. Regular corresponds to question e), Option ii).
c) The system may exclude sleeves with wrist pressures below 18 mmHg. The 18 mmHg pressure sleeves are eliminated as applicable, since the compression requirement at the wrist is generally greater than 18 mmHg.
d) The level of compression is established according to the following logic, where, for example, “Q b)” represents the answer to question b) in the Questions section above.
   i. if [Q b)!=3]→compression class
   ii. else
   iii. if [Q c)=1] (for prevention))→CLASS 1
   iv. else
   v. if [Q d)=1] (compression sensitive)→CLASS 1
   vi. else if [Q d)=3]→CLASS 2
   vii. else
   viii. show options
e) The sleeves that have graduated compression with known compression are established. For the remaining sleeves (the first four steps a)-d) above are the same), those for which wrist to forearm compression difference and/or Forearm to Upperarm compression difference is less than 4.5 mmHg are eliminated. In other words, they are eliminated if (wrist-forearm)<4.5 mmHg|(forearm-upperarm)<4.5 mmHg.
f) If the number of remaining sleeve options equals 0, then a message is returned stating “Sorry! Patient will not receive adequate or appropriate compression based on his/her measurements”
g) The appropriate garment is decided upon. Of the sleeve or sleeves left, if Class 1 is chosen at question b), and there are no sleeves with “wrist” =>20 mmHg and <=30 (mmHg), or if Class 2 is chosen at question b) and there are no sleeves with “wrist'=>30 mmHg and =<40 mmHg, then a message is returned that Lymphedivas cannot fit this person.
h) If Class 1 or 2 is chosen, and if only one sleeve is left as an option, then that sleeve is reported as the correct fit.
i) If Class 1 or 2 is chosen, and if at least two sleeves are left in the class category, then:
   i. If sensitive to compression is selected, then the lower pressure wrist pressure is selected
   ii. If not sensitive to compression is selected, then all options are shown in order of compression (highest to lowest)
j) The right compression class is selected, if not already known.
k) A Hand garment is selected. In particular, hand garments having compressions that are too low are eliminated from further consideration.
   i. If palm pressure is less than wrist pressure, eliminate hand garment.
   ii. If palm pressure is greater than or equal to wrist pressure, hand garment is viable.
   iii. If palm pressure is greater than 10 mmHg more than wrist pressure, eliminate hand garment.
   iv. If palm pressure is greater than 5 mmHg more than wrist pressure, de-prioritize suggestion.

### Example Hand Garment

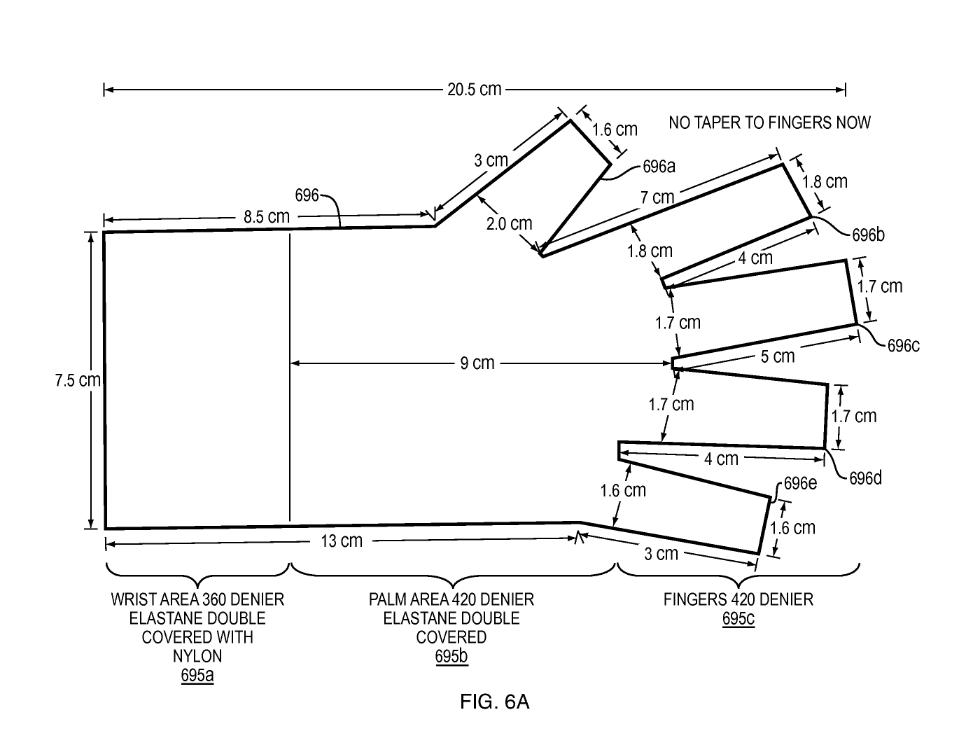

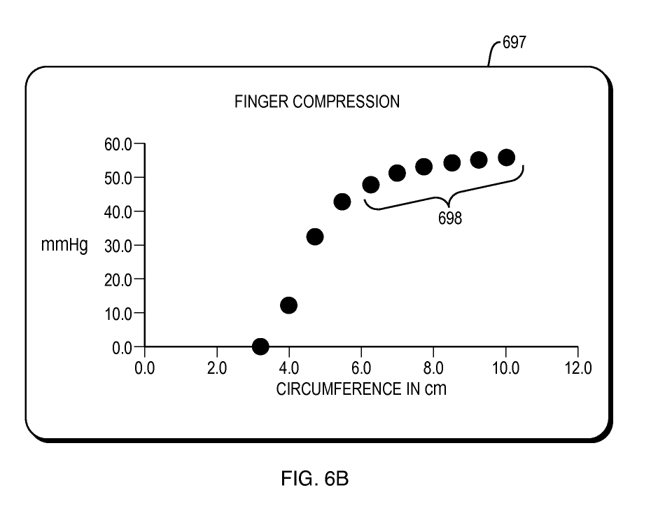

FIG. 6A illustrates an example hand garment 696 that can be fitted to a patient according to embodiment devices and corresponding methods. A thumb 696a is tapered, having a smaller diameter at its extremity than closer to the palm. Fingers 696b-e are not tapered, but other embodiments have tapered fingers as well as a tapered thumb. In addition to the example dimensions shown in FIG. 6A, which are in centimeters, spacings between the thumb 696a and fingers 696b-e can be 0.3 cm, for example.

The example hand garment 696 has a wrist area 695a made of 120-360 denier elastane double covered with nylon. A palm area 695b is composed of 300-420 denier elastane double covered with nylon. A finger area 695 is composed of 400-420 denier elastane. In other embodiments, other yarns can be used.

In one embodiment, a hand garment is made of lycra/nylon. In some embodiments, a finger gauge can provide a more comfortable fabric. Some embodiments have seamless construction that allows the garment to lie flat. The ability to lie flat can be a requirement to be able to press patterns into garments during manufacturing. In one example, a hand garment is made without latex or spandex laid in, but instead is knit using nylon covered spandex.

FIG. 6B shows a graph 697 of an example finger compression versus circumference for an example hand garment with un-tapered fingers. A prominent feature of the graph 698 is a flatter region 698, where there is less variation in compression with changing circumference. A flatter region makes the garment easier to fit and apply correct compression to a variety of finger sizes. Garments preferably have no greater than 4 mmHg change in finger compression over a 1 cm change in circumference.

This flatness or smaller variation in compression can be achieved by a combination of factors. One way to provide the garment with the ability to fit a wider range of finger girths is to narrow the unstretched or flat girth so that the stated size ranges are found when the glove fingers are stretched between 80% and 130% of the un-stretched finger.

### Recommendation System Analytics

Information related to user input/selections and corresponding compression garment recommendations, including information regarding which recommended garments result in a commercial sale versus those that were recommended but ultimately not purchased, can be used to improve the quality of the recommendation engine. For example, an analytics tool (such as a web analytics tool or BI tool) may produce various metrics such as measures of garment purchase success based on the combination of other criteria (e.g. recommendations provided), and filter these results by time of the day or time period or location. Such measures can be viewed per compression garment to help improve the recommendation engine/agent/tool because the results may be aggregated across a multitude of compression garments.

An analytics tool offers the possibility of associating other quantitative data beside frequency data with a compression garment purchase. For instance, the results of a recommendation could be joined against the metrics derived by an analytics system (such as a web analytics solution or a business intelligence solution).

Furthermore, analytics data for compression garments can be aggregated per type of limb. For example, it could be of interest to know which types of garments are most or least conducive to commercial orders (in this case, checkout completion and/or shopping cart value could be the relevant analytics metrics that are joined with the result of the recommendations made), or on the contrary cancelations (in which case shopping cart abandonment may be the relevant metric).

Some analytics measures, for example measures of compression garment purchases, correlate with the quality of the recommendation engine's recommendations. Accordingly, aggregating such measures per garment and displaying the results to a reviewer provides straightforward clues to areas the reviewer needs to act upon in order to improve the quality of the recommendation engine.

While this invention has been particularly shown and described with references to example embodiments thereof, it will be understood by those skilled in the art that various changes in form and details may be made therein without departing from the scope of the invention encompassed by the appended claims.

For example, while reference is made to particular limbs, such as arms or hands, those skilled in the art would appreciate that any limb or body part may be suitable for the compression garment recommendations recommended by the disclosed recommendation tools/engines 115 herein.

1. A data processing system for fitting compression garments, the system comprising:
a handler configured to receive a measurement of a person's limb and additional information related to a compression need of the person; and
a recommendation engine, in communication with the handler, the engine being configured to calculate an expected compression predicted to be applied by a given compression garment to the person's limb based upon the measurement of the limb and upon a known relationship between a known compression applied by the given garment and a size of the given garment, the engine being configured to determine whether the given compression garment meets the compression need of the person based upon the expected compression and upon the additional information related to the compression need.

2. The data processing system of claim 1, wherein the limb is an arm.

3. The data processing system of claim 2, further including:
the handler configured to receive a measurement of a palm of a hand connected to the arm of the person; and
the recommendation engine is configured to compute an expected palm compression predicted to be applied by a hand garment to the palm based upon the measurement of the palm.

4. The data processing system of claim 3, further including:
the measurement of the arm being a measurement of a wrist of the arm; and
the expected compression being an expected wrist compression predicted to be applied to the person's wrist, and wherein the recommendation engine is further configured to deprioritize consideration of the hand garment based upon a difference between the expected palm compression and the expected wrist compression.

5. The data processing system of claim 1, wherein the handler is further configured to receive a length of the person's arm.

6. The data processing system of claim 1, wherein the size of the given garment is at least one of a circumference, a radius, and a diameter of the given garment when the given garment is fitted over an object of a known dimension.

7. The data processing system of claim 1, wherein the limb is a leg.

8. The data processing system of claim 1 further comprising:
the expected compression being configured as a first expected compression predicted to be applied to a first portion of the limb, and wherein the handler is further configured to detect input from the user related to a second measurement of the person's limb; and
the recommendation engine being configured to compute a second expected compression predicted to be applied by the given compression garment to a second portion of the limb based upon the information related to the second measurement of the limb and upon a second known relationship between a second known compression applied by the given garment and a second size of the given garment.

9. The data processing system of claim 1, wherein the given compression garment is a given pre-made compression garment of a standard size.

10. The data processing system of claim 9, wherein the recommendation engine is further configured to select a pre-made compression garment of a standard size from among the given pre-made compression garment of the standard size and at least one additional pre-made compression garment of at least one respective additional size, the selected garment being selected to meet the compression need of the person.

11. The data processing system of claim 10, wherein the recommendation engine is further configured to output at least one of the expected compression and the selected garment.

12. The data processing system of claim 1, wherein the additional information related to the compression need of the person is at least one of a desired compression, a desired compression class, whether the compression need is for prophylaxis, and an indication of compression sensitivity of the person.

13. The data processing system of claim 12, wherein the recommendation engine is further configured to determine, based at least upon the compression need information, a garment compression class applicable to the person.

14. The data processing system of claim 12, further comprising:
the compression need information being processed as a positive indication of compression sensitivity of the person; and
the expected compression of the given garment being processed as a lowest expected compression of a set of garments with acceptable expected compression, and wherein the engine is configured to determine that the given compression garment meets the compression need of the person based upon the lowest expected compression and upon the positive indication of compression sensitivity.

15. The data processing system of claim 1, wherein the handler and the recommendation engine are executing components at one or more computing devices including at least one of a server, a terminal, a desktop computer, a laptop computer, a tablet computer, a handheld computer, a cell phone, and a processor.

16. The data processing system of claim 1, further comprising an indicator configured to indicate to the user at least one of a location on the limb in which to obtain the measurement to be received and a manner in which to obtain the measurement to be received.

17. A computer implemented method of fitting compression garments executing at one or more processors, the method comprising:
receiving a measurement of a limb of a person; and
calculating an expected compression predicted to be applied by a given compression garment to the limb of the person based upon the measurement of the limb and upon a known relationship between a known compression applied by the given garment and a size of the garment;
receiving additional information related to a compression need of the person; and
determining whether the given garment meets the compression need of the person based upon the expected compression and upon the additional compression need information according to a computer implemented logic flow.

18. (canceled)

19. The computer implemented method of claim 17 wherein limb is an arm and the size is a circumference of the given garment when the given garment is fitted over a cylindrical object of known circumference, and wherein the measurement of the arm is a circumference of the arm.

20. The computer implemented method of claim 19, wherein the circumference of the arm is a circumference of a wrist of the arm and the expected compression is an expected wrist compression, the method further comprising receiving circumferences of the middle-lower arm and middle-upper arm and calculating respective expected middle-lower arm and middle-upper arm compressions predicted to be applied by the given compression garment, respectively to the middle-lower arm and middle-upper arm of the person based upon the respective measurements, and wherein the determining is further based upon at least one of the expected compressions expected to be applied to the middle-lower arm and middle-upper arm of the person.

21. The computer implemented method of claim 20, wherein the determining is further based upon a difference between two of the palm, wrist, middle-lower arm, and middle-upper arm expected compressions.

22. The computer implemented method of claim 20, further comprising:
receiving a measurement of a palm of a hand connected to the arm of the person;
calculating an expected palm compression predicted to be applied by a hand garment to the palm based upon the measurement of the palm; and
eliminating the hand garment from consideration and deprioritizing consideration of the hand garment based upon a difference between the expected palm compression and the expected wrist compression.

23-24. (canceled)

25. The computer implemented method of claim 18, further comprising indicating to the user at least one of a location on the arm in which to obtain the measurement to be received and a manner in which to obtain the measurement to be received.

26. The computer implemented method of claim 17, wherein the given compression garment is a given pre-made compression garment of a predetermined size; and
selecting a pre-made compression garment of a predetermined size from among the given pre-made compression garment of the predetermined size and at least one additional pre-made compression garment of at least one additional, respective predetermined size, the selected garment being selected to be suitable for the compression need of the person.

27-28. (canceled)

29. The computer implemented method of claim 17, wherein the additional information related to the compression need of the person is at least one of a desired compression, a desired compression class, whether the compression need is for prophylaxis, or an indication of compression sensitivity of the person;
determining, based at least upon the additional compression need information, a garment compression class applicable to the person; and
wherein the additional compression need information is a positive indication of compression sensitivity of the person; and
wherein the expected compression of the given garment is a lowest expected compression of a set of garments with acceptable expected compression, and wherein the given garment is determined to meet the compression need of the person in response to the positive indication of compression sensitivity.

30-31. (canceled)

32. The computer implemented method of claim 17, the receiving a measurement, the calculating, the receiving additional compression need information, and the determining being performed by at least one of a server, a terminal, a desktop computer, a laptop computer, a tablet computer, a handheld computer, a cell phone, and a processor.

33. The computer implemented method of claim 17, wherein the size of the given garment is at least one of a circumference, a radius, and a diameter of the given garment when the given garment is fitted over an object of a known dimension.

34. A computer program product stored on a non-transitory computer readable medium, the computer program product including computer readable instructions that cause one or more processors to:
receive a measurement of a body part of a person;
compute an expected compression predicted to be applied by a given compression garment to the body part of the person based upon the measurement of the body part and upon a known relationship between a known compression applied by the given garment and a size of the garment;
receive additional information related to a compression need of the person; and
determine whether the given compression garment meets a compression need of the person based upon factoring of the expected compression and upon the additional compression need information to facilitate a recommendation for the person.
